(19) United States
(12) Patent Application Publication
(10) Pub. No.: US 2024/0104989 A1
(43) Pub. Date: Mar. 28, 2024

(54) SYSTEM FOR MONITORING AN ENTRY RESTRICTED DANGER ZONE

(71) Applicant: Pilz GmbH & Co. KG, Ostfildern (DE)

(72) Inventors: Christoph BAUMEISTER, Ostfildern (DE); Peter SCHUSTER, Ostfildern (DE); Christoph ZELL, Ostfildern (DE)

(21) Appl. No.: 18/474,614

(22) Filed: Sep. 26, 2023

(30) Foreign Application Priority Data
Sep. 26, 2022 (DE) 10 2022 124 673.6

(51) Int. Cl. G07C 9/27; G07C 9/28

(52) U.S. Cl. CPC G07C 9/27; G07C 9/28

(57) ABSTRACT

A system for monitoring an entry-restricted danger zone of an industrial plant, wherein a machine is arranged inside the entry-restricted danger zone, the system comprising: a safety control apparatus to control operation of the machine in a fail-safe manner; an entry portal to enable a person to enter and exit the danger zone; an entry control apparatus to authenticate entry of authorized persons, the entry portal being assigned to the entry control apparatus; and a login controller to log information about a current entry event of the entry-restricted danger zone and about historical entry events of the entry-restricted danger zone, wherein the safety control apparatus is configured to generate, upon request of an authenticated, entry-authorized person, a switch-off signal for a fail-safe shutdown of the machine and to prevent a restart of the machine while at least one person is still present inside the entry-restricted danger zone.

### CROSS REFERENCE TO RELATED APPLICATIONS

This application claims priority under 35 U.S.C. § 119(a)-(d) to German application No. 10 2022 124 673.6 filed on Sep. 26, 2022, the entire contents of which are hereby incorporated by reference.

### TECHNICAL FIELD

The present disclosure relates to a system for monitoring an entry-restricted danger zone.

### BACKGROUND

Almost every industrial plant has one or more safety-critical and, therefore, entry-restricted danger zones, where machines operate in an automated manner and where the normal operation and/or operating errors and/or technical defects pose a risk to the life and limb of the operating and maintenance personnel and/or a risk of damage to the production equipment.

On the one hand, such safety-critical danger zones must be protected by suitable measures, in particular, protective apparatus; and, on the other hand, when a machine enters a danger zone to perform its task, it is important to ensure that the machine is not started up again, as long as there is still a person in the danger zone of the machine.

The difficulty is compounded here by the fact that the entry-restricted danger zones of industrial plants are often highly complex and/or have a wide variety of ways to gain entry due to the size of the plants, so that frequently it cannot be reliably ensured that an individual person can rule out with the necessary degree of certainty that other persons will not be in the entry-restricted danger zone of the machine before the machine is put into operation again.

On the other hand, due to the growing trend towards individualization of products and, thus, a reduction in the batch size, plant manufacturers are increasingly responding with greater modularization of plants in the form of spatially closed plant cells in which one or more machines work. The result of such modularization is generally that the entry-restricted danger zones of an industrial plant can no longer be reliably protected by a higher-ranking safety concept. As a result, each plant cell of the industrial plant needs an adapted and optimized safety concept. The advantage of such a cell-oriented safety approach is that, for example, in the case of maintenance or testing of an individual plant cell, the entire industrial plant does not have to be shut down, but rather such maintenance and testing can be performed cell by cell. However, the result of such an approach is that the safety system, which, for example, in the case of maintenance, prevents a restart, has to cope with an additional degree of complexity.

These conflicting priorities give rise to the problem to be addressed the disclosed system for monitoring at least one entry-restricted danger zone such that the system can reliably ensure that when the at least one machine, working in the entry-restricted danger zone, is restarted, there will no longer be any person in the entry-restricted danger zone and that, in addition, the system makes it also possible to document the historical entry event.

### SUMMARY

An innovative system for monitoring at least one entry-restricted danger zone of an industrial plant, wherein at least one machine, in particular, a robot, is arranged inside the at least one entry-restricted danger zone, comprises:
a safety control apparatus that is designed to control the operation of the at least one machine with a high degree of fail-safety;
at least one entry portal that is designed to enable a person to enter the at least one entry-restricted danger zone and to exit the at least one entry-restricted danger zone, wherein the entry portal is assigned an entry control apparatus that is designed to authenticate entry authorized persons; and
a login controller that is designed to log information about the current entry event of the at least one entry-restricted danger zone and about the historical entry event of the at least one entry-restricted danger zone, wherein the safety control apparatus is designed to generate upon the request by an authenticated, entry authorized person a switch-off signal for a fail-safe shutdown of the at least one machine and to prevent a restart of the at least one machine, as long as there is still at least one person inside the associated entry-restricted danger zone.

The disclosed system has the advantage that it can be used even in large industrial plants with a plurality of plant cells, which have in each case an entry-restricted danger zone. The system detects when persons have entered one of the plant cells via various entry points, for example, for maintenance purposes, or have left the plant cells again. Therefore, the at least one automated machine, which is located inside the entry-restricted danger zone and which may be, in particular, a robot, can be restarted immediately after the maintenance work has been completed and after all persons have left the protected danger zone. Therefore, there is no need to wait until the persons have returned to their original entry point. Another application of the system that is proposed herein is, for example, a building with at least two building parts that are separated from each other by a danger zone. In order to go through the danger zone, after the entry control point (for example, in the first part of the building), the at least one machine, which is working inside the danger zone, is stopped. If there is no intention of returning to the original login point, thus, the entry control point, in the first part of the building, since another part of the building is to be entered, then the logout process can be done at the entry portal in the second part of the building.

In addition, there is also the advantage of security against tampering, since each person who is authorized to enter can be assigned a unique code (personal ID) via a personal identification medium. Thus, it is not possible for unauthorized persons to penetrate one of the entry-restricted danger zones of the industrial plant without being noticed. Similarly, it is also not possible to reactivate and to set the machines in motion in an unsafe state of the plant cells.

One particular advantage of the system lies in the fact that not only the current, but also the past entry behavior can be logged and, hence, can be completely documented in order to enable, for example, an audit trail.

In one preferred embodiment, it is proposed that the login controller have a volatile storage medium, in which an entry control list with information about the current entry event inside the at least one entry-restricted danger zone is stored for retrieval.

In one particularly preferred embodiment, it is proposed that the login controller have a non-volatile storage medium, in which an entry documentation list or an entry documentation database with information about the historical entry event inside the at least one entry-restricted danger zone is stored for retrieval.

In one advantageous embodiment, there is the possibility that the login controller is designed to transmit, following the authentication of a person to exit the entry-restricted danger zone, the associated list entry of the person from the entry control list together with a time stamp, which represents the point in time of the exit from the entry-restricted danger zone, into the entry documentation list or the entry documentation database and to delete the list entry of the person from the entry control list. Owing to the transmission of the entries from the entry control list, the entries being stored in the temporary, volatile storage medium, into the entry documentation list or into the entry documentation database, which is stored for retrieval in the non-volatile storage medium, not only the current entry event, but also the historical entry event of the entire industrial plant as well as the individual plant cells or entry-restricted danger zones are logged electronically and, in so doing, are also documented.

In one particularly advantageous embodiment, it can be provided that the safety control apparatus is designed, upon receiving a request to switch on a machine that has been switched off, to send to the login controller a query request to query existing list entries in the entry control list and that the login controller is designed, upon receiving this query request in the entry control list, to perform a query about the entries in the list and to transmit the result of this query to the safety control apparatus. In this way, the system also enables, in particular, cell-based maintenance of the industrial plant. The system detects when persons such as, for example, the maintenance service are servicing different plant cells of the plant. By comparing the respective entry control lists it is possible to explicitly check the plant cell(s), in which persons are currently present, so that a restart of the machines in these plant cells has to be absolutely prevented. This aspect has the advantage that the production can be kept running in all of the other plant cells.

Preferably, the safety control apparatus can be designed to generate at least one triggering signal for an interlocking device of the at least one entry portal, in order to unlock the entry portal in an automated manner after authentication of a person. As a result, it is possible to unlock the at least one entry portal in an automated manner before entering and after exiting the entry-restricted danger zone. Preferably, the at least one entry portal can also be locked again in an automated manner by the interlocking device in that the safety control apparatus generates a corresponding triggering signal.

In one embodiment, it is possible that a common entry control list is assigned to all of the entry-restricted danger zones of the industrial plant.

In one alternative embodiment, it is also possible that each of the entry-restricted danger zones of the industrial plant is assigned an own entry control list.

In one embodiment, it is proposed that the login controller be designed as a programmable logic controller, in particular, as a programmable logic fail-safe controller. The login controller and the safety control apparatus in this embodiment are two separate components of the system.

In order to obtain a higher degree of system integration, the login controller in an alternative embodiment can also be designed so as to be integral with the safety control apparatus.

### BRIEF DESCRIPTION OF THE DRAWINGS

Other features and advantages of example embodiments of the disclosed system are described below with reference to the drawings.

FIG. 1 illustrates a highly simplified plan view in schematic form of an industrial plant with a system for monitoring at least one entry-restricted danger zone, where the system is designed according to an example embodiment of the disclosed system.

FIG. 2 is a schematic representation of an entry control apparatus of the system.

### DETAILED DESCRIPTION

It is not necessary for an innovative system for monitoring at least one entry-restricted danger zone 5a, 5b to exhibit all of the features described below. It is also possible that a system according to the present disclosure exhibits only individual features of the example embodiments described below.

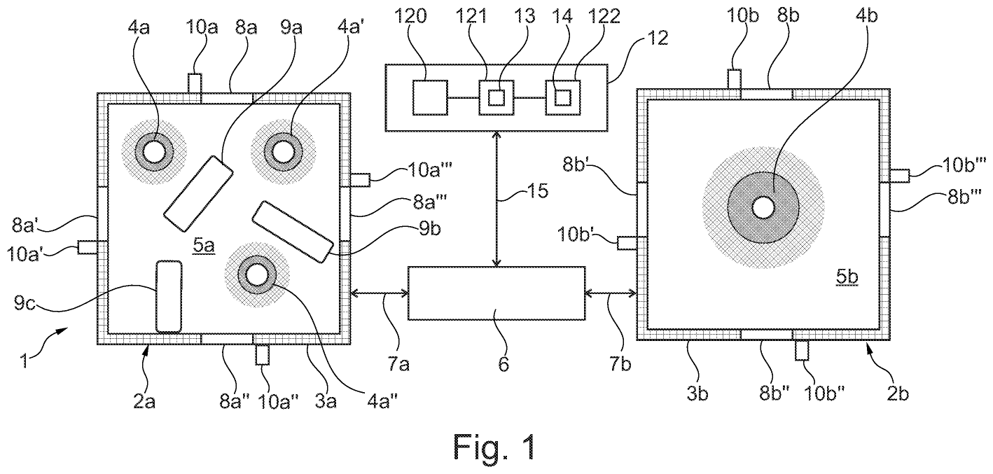

With reference to FIG. 1, an industrial plant 1 is shown there in a plan view in a very highly simplified schematic form. The industrial plant 1 in this example embodiment has, as an example, two plant cells 2a, 2b, which in the present embodiment are respectively spatially restricted by a fence 3a, 3b, in particular, by a metal grid fence. Larger industrial plants generally have a plurality of such plant cells 2a, 2b. In each of the plant cells 2a, 2b, there is/are one or more automated machines 4a, 4a′, 4a″, 4b, where the machines may be, in particular, industrial robots.

In this example embodiment a first plant cell 2a, shown on the left side in FIG. 1, has in total three automated machines 4a, 4a′, 4a″, in particular, robots. In contrast, a single, automated machine 4b, in particular, a robot is provided in a second plant cell 2b. The internal spaces of the plant cells 2a, 2b, defined respectively by the associated fence 3a, 3b, each form an entry-restricted danger zone 5a, 5b of the relevant plant cell 2a, 2b.

In addition, the industrial plant 1 has at least one safety control apparatus 6 by which the operation of the machines 4a, 4a′, 4a″, 4b, working inside the plant cells 2a, 2b, can be controlled in a fail-safe manner. For this purpose, the safety control apparatus 6 is in bi-directional communication 7a, 7b with each of the two plant cells 2a, 2b. The bi-directional communication 7a, 7b, which is represented by a double arrow in the present case, can be used to drive the machines 4a, 4a′, 4a″, 4b in a fail-safe mode.

The safety control apparatus 6 is designed, while it is operating, to receive corresponding data reliably from the plant cells 2a, 2b, to evaluate the data reliably and, based thereon, to control the operation of the machines 4a, 4a′, 4a″, 4b inside the plant cells 2a, 2b in a safe way. One task of the safety control apparatus 6 consists of the feature that in the event of a hazardous situation that is signaled by a status signal of a signaling device, which is not shown here explicitly, the safety control apparatus is to bring the machines 4a, 4a′, 4a″, 4b into a non-hazardous state for persons. Examples of such signaling devices are emergency OFF and emergency STOP switches and—in particular, in the case of robotic systems—also enable switches. Thus, the safety control apparatus 6 is designed, in the event of a fault or a malfunction, to bring the machines 4a, 4a′, 4a″, 4b inside the plant cells 2a, 2b into a non-hazardous operating state for persons. This is done preferably for plant cells 2a, 2b independently of each other. In principle, however, it is also possible, in the event of a fault or a malfunction in one of the plant cells 2a, 2b, to bring the machines 4a, 4a′, 4a″, 4b of the entire industrial plant 1 into a non-hazardous operating state for persons.

Each of the plant cells 2a, 2b has one or more ways to gain entry that in the present case can be achieved by corresponding entry portals 8a, 8a′, 8a″, 8a′″, 8b, 8b′, 8b″, 8b′″ that can be designed, for example, as entry doors. In the present case, each of the two plant cells 2a, 2b has in each case four entry portals 8a, 8a′, 8a″, 8a′″, and 8b, 8b′, 8b″, 8b′″, respectively.

If one or more persons would like to enter one of the plant cells 2a, 2b—for example, for maintenance purposes—and, as a result, enter one of the entry-restricted danger zones 5a, 5b, then it has to be ensured by suitable measures that each of the machines 4a, 4a′, 4a″, 4b inside the relevant plant cell 2a, 2b is switched off prior to the intended entry and, thus, no longer poses a risk to persons. Not until each of the machines 4a, 4a′, 4a″, 4b has been switched off can persons safely enter the relevant plant cell 2a, 2b. Furthermore, it has to be ensured that a restart of the machines 4a, 4a′, 4a″, 4b is effectively prevented, as long as persons are still present in the entry-restricted danger zones 5a, 5b inside the plant cells 2a, 2b. When one or more persons enter the entry-restricted danger zone 5a of the first plant cell 2a, the machines 4a, 4a′ and 4a″ that are working in the entry-restricted danger zone are switched off prior to the entry. In contrast, the machine 4b inside the entry-restricted danger zone 5b of the second plant cell 2b can continue to run (and vice versa), so that, for example, cell-based maintenance of the plant 1 is also possible.

The described system, which is designed for monitoring the entry-restricted danger zones 5a, 5b inside the respective plant cells 2a, 2b of the industrial plant 1, can ensure that only authorized and, thus, as a matter of fact, entry of authorized persons, in particular, the maintenance and service personnel, can enter and exit again the plant cells 2a, 2b via any entry portal 8a, 8a′, 8a″, 8a′″, 8b, 8b′, 8b″, 8b′″. A visual check to verify whether persons are or are not present inside the entry-restricted danger zones 5a, 5b of the plant cells 2a, 2b is very often not possible in practice. Because, in addition to the machines 4a, 4a′, 4a″, 4b, other objects and/or equipment that form additional visual barriers 9a, 9b, 9c and render a reliable visual check impossible may also be present inside the plant cells 2a, 2b. This has been illustrated in FIG. 1 on the left side by the visual barriers 9a, 9b, 9c, shown there for the first plant cell 2a as an example.

Each of the entry portals 8a, 8a′, 8a″, 8a′″, 8b, 8b′, 8b″, 8b′″ of the plant cells 2a, 2b is assigned a respective entry control apparatus 10a, 10a′, 10a″, 10a′″, 10b, 10b′, 10b″, 10b′″, which interacts functionally with the relevant entry portal 8a, 8a′, 8a″, 8a′″, 8b, 8b′, 8b″, 8b′″ and with which the entry authorization of persons can be checked in a suitable manner.

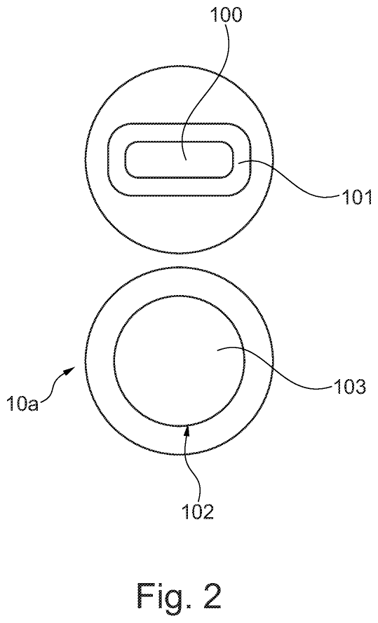

Each of the entry control apparatuses 10a, 10a′, 10a″, 10a′″, 10b, 10b′, 10b″, 10b′″ is designed to receive personal identification data, which are assigned to clearly specified persons and to evaluate the personal identification data, in particular, by comparing with the entry authorization data. For example, the personal identification data, in particular, in the form of a unique personal ID can be stored electronically for retrieval in a personal identification medium, which a person carries with him. This personal identification medium may be, for example, a transponder key. This transponder key can be inserted into a read interface 100 (shown in FIG. 2), provided for this purpose, of one of the entry control apparatuses 10a, 10a′, 10a″, 10a′″, 10b, 10b′, 10b″, 10b′″, with which the personal identification data, stored in the transponder key, can be read out, so that the personal identification data can be compared with the entry authorization data. The data transmission from the identification medium, in particular, from the transponder key, to the read interface 100 can also be done wirelessly in certain embodiments, in particular, via a reliable, wireless near field communication interface. Then, for the entry control process it would be sufficient for a person to hold the identification medium simply in front of or in the vicinity of the read interface 100 of the relevant entry control apparatus 10a, 10a′, 10a″, 10a′″, 10b, 10b′, 10b″, 10b′″ or—as is often the case in motor vehicles—to just simply carry the identification medium with him.

Other details of a possible embodiment of the entry control apparatuses 10a, 10a′, 10a″, 10a′″, 10b, 10b′, 10b″, 10b′″ are explained below in greater depth with reference to FIG. 2. Instead of a transponder key, it is also possible to use other personal identification mediums, in which personal identification data are stored for retrieval.

By evaluating the personal identification data and by comparing with the entry authorization data it is possible to identify persons via the entry control apparatuses 10a, 10a′, 10a″, 10a′″, 10b, 10b′, 10b″, 10b′″ and to check via an authentication process as to whether the persons in question are or are not authorized to enter the entry-restricted danger zone 5a, 5b of the associated plant cells 2a, 2b.

As will be explained below in greater detail, the system presented here can be used to keep one or several functionally reliable, in particular, cell-based entry control lists 13, with which both the entry into and also the exiting out of the plant cells 2a, 2b of the industrial plant 1 are documented. Prior to entering one of the plant cells 2a, 2b, the personal identification data of a person are checked for the authorization to entry. In the case of a positive check, the data, which are provided with a first time stamp indicating a point in time of the entry and from which at least the identity of the person can also be determined, are stored for retrieval in the entry control list 13 in a volatile (temporary) storage medium 121. Upon exiting the entry-restricted danger zone 5a, 5b, these data are deleted from the entry control list 13. At the same time, all of the changes in the entry control list 13 together with the corresponding time stamps, which provide information about the point in time of the entry into (with a first time stamp) and about the point in time of the exit (with a second time stamp) out of the respective plant cell 2a, 2b of the industrial plant 1, are stored for retrieval in a permanent, non-volatile storage medium 122 for the purpose of plant documentation.

Each of the entry control apparatuses 10a, 10a′, 10a″, 10a′″, 10b, 10b′, 10b″, 10b′″ is designed to transmit a first authentication information to the safety control apparatus 6, when the check of the entry authorization of a person is positive and, hence, this person has the authorization to enter the entry-restricted danger zone 5a, 5b of the associated plant cell 2a, 2b. The safety control apparatus 6 is designed to evaluate the first authentication information. Preferably, the safety control apparatus 6 is designed such that it can also conduct a plausibility test in this step.

Furthermore, the safety control apparatus 6 is designed, after receiving a request signal of the entry authorized person, to safely shut down the machines 4a, 4a′, 4a″, 4b inside the associated plant cells 2a, 2b and to unlock an interlocking device (not explicitly shown here) of the entry portals 8a, 8a′, 8a″, 8a′″, 8b, 8b′, 8b″, 8b′″, at which the person has authenticated himself with the aid of the associated entry control apparatus 10a, 10a′, 10a″, 10a′″, 10b, 10b′, 10b″, 10b′″, by a corresponding triggering signal. After the authorized and, thus, entry authorized person has entered the entry-restricted danger zone 5a, 5b of the relevant plant cell 2a, 2b through the corresponding entry portal 8a, 8a′, 8a″, 8a′″, 8b, 8b′, 8b″, 8b′″, this entry portal 8a, 8a′, 8a″, 8a′″, 8b, 8b′, 8b″, 8b′″ is automatically locked again by the interlocking device. For the aforementioned purposes, the safety control apparatus 6 generates corresponding triggering signals for the machines 4a, 4a′, 4a″, 4b and for the interlocking device that is assigned to the relevant entry portal 8a, 8a′, 8a″, 8a′″, 8b, 8b′, 8b″, 8b′″.

When the entry authorization of a person has been verified and, thus, the person has also been authenticated, the person may open the entry portal 8a, 8a′, 8a″, 8a′″, 8b, 8b′, 8b″, 8b′″, after the at least one machine 4a, 4a′, 4a″, 4b, which is present inside the plant cell 2a, 2b, has been shut down. Then the person may remove the identification medium from the read interface 100 and enter the relevant plant cell 2a, 2b. Only after all of the previously logged-in persons in the respective plant cell 2a, 2b have exited the cell again at a later point in time and have logged out again with their personal identification mechanism, in particular, their transponder key, can the entry portal 8a, 8a′, 8a″, 8a′″, 8b, 8b′, 8b″, 8b′″ be locked again, before the at least one machine 4a, 4a′, 4a″, 4b inside the plant cell 2a, 2b can be subsequently restarted.

Furthermore, the system presented here has a login controller 12 that is designed, in particular, as a programmable logic control apparatus, preferably as a programmable logic fail-safe control apparatus and is in bi-directional communication 15 with the central safety control apparatus 6. In the present case, the login controller 12 is a separate component of the system.

The login controller 12 has at least one processor 120; a temporary, volatile storage medium (RAM storage medium) 121; and a non-volatile storage medium 122. Furthermore, the login controller 12 has a software program, which is stored for retrieval in the non-volatile storage medium 122 and which maps the structure of the entire industrial plant 1 and the plant cells 2a, 2b and comprises the instructions, which are carried out by the processor 120 while the system is operating. Inside the volatile storage medium 121, the aforementioned entry control list 13 is stored. If a person has successfully logged in at one of the entry control apparatuses 10a, 10a′, 10a″, 10a′″, 10b, 10b′, 10b″, 10b′″ and, thus, has authenticated himself, the login controller 12 receives from the safety control apparatus 6 the corresponding person-related information, in particular, the information about which person has authenticated himself at what clock time (first time stamp) at which of the entry control apparatuses 10a, 10a′, 10a″, 10a′″, 10b, 10b′, 10b″, 10b′″ of the plant modules 2a, 2b. This information is processed by the login controller 12 and transmitted into the entry control list 13, which is stored with the aid of the volatile storage medium 121. Furthermore, the login controller 12 has an entry documentation list 14 or an entry documentation database, which is stored for retrieval in the non-volatile storage medium 122 and with which the entire historical entry event inside the plant cells 2a, 2b can be documented. As a result, an audit trail of the plant cells 2a, 2b and the entire industrial plant 1 can be provided in an advantageous way. As an alternative, the login controller 12 can also be integrated into the safety control apparatus 6. Then the processor 120 of the login controller 12 can be identical preferably to the processor of the safety control apparatus 6. If the safety control apparatus 6 has a modular design, then the login controller 12 can form a module of this safety control apparatus 6.

If a person would like to exit the previously entered plant cell 2a, 2b again through one of the entry portals 8a, 8a′, 8a″, 8a′″, 8b, 8b′, 8b″, 8b′″, where in this case it does not have to be necessarily the entry portal 8a, 8a′, 8a″, 8a′″, 8b, 8b′, 8b″, 8b′″, through which the person entered the plant module 2a, 2b, then the person must identify and authenticate himself again with the aid of the associated entry control apparatus 10a, 10a′, 10a″, 10a′″, 10b, 10b′, 10b″, 10b′″. To this end the identification medium, in particular, the transponder key, is inserted into the read interface 100. In the event of a positive authentication, a second person-related information is sent from the relevant entry control apparatus 10a, 10a′, 10a″, 10a′″, 10b, 10b′, 10b″, 10b′″ to the safety control apparatus 6 and processed by the safety control apparatus. At the same time a plausibility test is conducted once again, if necessary. A corresponding triggering signal, which is generated by the safety control apparatus 6, is used to unlock the interlocking device of that entry portal 8a, 8a′, 8a″, 8a′″, 8b, 8b′, 8b″, 8b′″ that is assigned the entry control apparatus 10a, 10a′, 10a″, 10a′″, 10b, 10b′, 10b″, 10b′″, at which the person authenticated himself. After exiting the plant cell 2a, 2b, the entry portal 8a, 8a′, 8a″, 8a′″, 8b, 8b′, 8b″, 8b′″ is closed and locked again by the associated interlocking device.

In addition, a request to remove the person-related list entry from the entry control list 13 is generated by the safety control apparatus 6 and transmitted to the login controller 12. The login controller 12 receives this request to remove the person-related list entry, which comprises the associated personal identification data (personal ID), the first time stamp (point in time of the entry into the plant cell 2a, 2b) and, in addition, also a second time stamp (point in time of the exit from the plant cell 2a, 2b), and processes the data. The associated person-related list entry, which is stored in the entry control list 13, is subsequently stored for retrieval in the entry documentation list 14 or in the entry documentation database in the non-volatile storage medium 122, so that even at a later date it is possible to track via the historical entry data at which points in time, which persons have entered the plant cells 2a, 2b and exited again. Subsequently, the person-related list entry is removed from the entry control list 13 and, in so doing, deleted from the volatile storage medium 121.

If, after exiting the plant cell 2a, 2b, a person would like to restart again the machines 4a, 4a′, 4a″, present in the plant cell 2a, or the machine 4b, which is present in the plant cell 2b, and performs a corresponding operator input, which is transmitted to the safety control apparatus 6, it has to be ensured that no other persons are present in the entry-restricted danger zone 5a, 5b of the relevant plant cell 2a, 2b. Then the safety control apparatus 6 sends to the login controller 12 a query request to query the list entries in the entry control list 13. The login controller 12 receives this request to query the list entries and performs a query in the entry control list 13 about the entries therein. Preferably a binary query result, such as, for example, “1” for an empty entry control list 13 and “0” in the case of an entry control list 13 that is not empty, is generated and transmitted from the login controller 12 to the safety control apparatus 6.

The safety control apparatus 6 is designed to receive and to evaluate the query result of the login controller 12. Thus, in the above-described example, the safety control apparatus 6 receives either the query result “1” (=entry control list 13 is empty) or “0” (=the entry control list 13 is not empty). In the case of the result “1” the safety control apparatus 6 generates one or more switch-on signals, in order to restart the shutdown machine(s) 4a, 4a′, 4a″, 4b. If, in contrast, the query result “0” is received, then the safety control apparatus 6 does not generate a switch-on signal to restart the machine(s) 4a, 4a′, 4a″, 4b. As a result, the industrial plant 1 stays in its current operating state. The operation of the individual plant cells 2a or 2b can be stopped and restarted separately in an advantageous manner, in order to enable the highest possible productivity of the industrial plant 1.

With reference to FIG. 2, other details of a possible example embodiment of the entry control apparatuses 10, 10a′, 10a″, 10a′″, 10b, 10b′, 10b″, 10b′″, which are designed so as to be preferably identical, shall be explained in greater depth via the entry control apparatus 10a, as an example.

The entry control apparatus 10a comprises a read interface 100 for receiving or for reading out wirelessly the identification medium, in particular, the transponder key, with a lighting device 101, which is designed to light up in at least two colors of light. A first light color signals to a person that the read interface 100 is ready to operate and, hence, can receive the identification medium or can read the identification medium wirelessly. A second light color signals that the read interface 100 has correctly read the identification medium, in particular, the transponder key, and has authenticated the person. Optionally the lighting device 101 can be designed to light up in at least one other color of light, in order to signal additional information, such as, for example, a read error or a defect.

Furthermore, the entry control apparatus 10a comprises a manually operable control knob 102, which has preferably an integrated lighting device 103, which can light up in at least a first color of light. After reading out the identification medium, in particular, the transponder key, via the read interface 100 and the correct authentication of a person, which is confirmed by the lighting device 101 of the read interface 100 by lighting up in the second color of light, the person can manually operate the control knob 102. This manual operation signals to the safety control apparatus 6 a shutdown request for the machine(s) 4a, 4a′, 4a″, 4b working inside the plant cell 2a, 2b. The completion of the shutdown process of the machine(s) 4a, 4a′, 4a″, 4b and/or the correct authentication of a person and the associated entry into the entry control list 13 can be confirmed in that the lighting device 103 of the control knob 102 lights up in the first color of light, for example, in the light color green. Then, entry into the plant cell 2a, 2b can take place via the entry portal 8a, 8a′, 8a″, 8a′″, 8b, 8b′, 8b″, 8b′″, and the identification medium can be removed by the person from the read interface 100, provided that it had been physically inserted into the read interface. The lighting device 103 of the control knob 102 can also be designed such that it can light up in at least a second color of light (for example, in the light color red), in order to optically visualize, for example, malfunctions.

The disclosed system and procedure which the system is based can ensure that the machines 4a, 4a′, 4a″, 4b inside the entry-restricted danger zones 5a, 5b cannot be restarted, as long as persons are still present in the relevant entry-restricted danger zone 5a, 5b. At least one functionally reliable entry control list 13 is kept, in which both the entry into and also the exiting out of the entry-restricted danger zones 5a, 5b are documented by corresponding time stamps. That means that when the person exits the entry-restricted danger zone 5a, 5b, the person-specific identification code is deleted from the entry control list 13 and, before restarting the at least one machine 4a, 4a′, 4a″, 4b, it is checked as to whether the entry control list 13 is empty. If this is the case, then the at least one machine 4a, 4a′, 4a″, 4b can be started. In the case that the entry control list 13 is not empty, then the restart is prevented. In principle, it is possible for one entry control list 13 to be used for all of the entry-restricted danger zones 5a, 5b. As an alternative, it is also possible to use an own, cell-related entry control list 13 for each of the entry-restricted danger zones 5a, 5b.

What is claimed is:

1. A system for monitoring an entry-restricted danger zone of an industrial plant, wherein a machine is arranged inside the entry-restricted danger zone, the system comprising:
a safety control apparatus to control operation of the machine in a fail-safe manner;
an entry portal to enable a person to enter and exit the entry-restricted danger zone;
an entry control apparatus to authenticate entry of authorized persons, the entry portal being assigned to the entry control apparatus; and
a login controller to log information about a current entry event of the entry-restricted danger zone and about historical entry events of the entry-restricted danger zone,
wherein the safety control apparatus is configured to generate, upon request of an authenticated, entry-authorized person, a switch-off signal for a fail-safe shutdown of the machine and to prevent a restart of the machine while at least one person is still present inside the entry-restricted danger zone.

2. The system of claim 1, wherein the login controller comprises a volatile storage medium to store for retrieval an entry control list with information about the current entry event of the entry-restricted danger zone.

3. The system of claim 2, wherein the login controller further comprises a non-volatile storage medium to store for retrieval an entry documentation list or an entry documentation database with information about the historical entry events of the entry-restricted danger zone.

4. The system of claim 3, wherein, following authentication of a person to exit the entry-restricted danger zone, the login controller is configured to transmit into the entry documentation list or into the entry documentation database an associated list entry of the person from the entry control list together with a time stamp representing a point in time of exit from the entry-restricted danger zone, and to delete the associated list entry of the person from the entry control list.

5. The system of claim 4, wherein:
upon receiving a request to switch on the machine, the safety control apparatus is configured to send to the login controller a query request to query existing list entries in the entry control list; and
upon receiving the query request, the login controller is configured to perform a query about entries in the entry control list and to transmit a result of the query to the safety control apparatus.

6. The system of claim 2, wherein the industrial plant comprises a plurality of entry-restricted danger zones, and wherein a common entry control list is assigned to all of the entry-restricted danger zones of the industrial plant.

7. The system of claim 2, wherein the industrial plant comprises a plurality of entry-restricted danger zones, and wherein each of the entry-restricted danger zones of the industrial plant is assigned its own entry control list.

8. The system of claim 1, wherein the safety control apparatus is configured to generate a triggering signal for an interlocking device of the entry portal in order to unlock the entry portal in an automated manner after authentication of a person.

9. The system of claim 1, wherein the login controller comprises a programmable logic controller.

10. The system of claim 9, wherein the programmable logic controller comprises a programmable logic fail-safe controller.

11. The system of claim 1, wherein the login controller is integral with the safety control apparatus.
